(19) United States
(12) Patent Application Publication
(10) Pub. No.: US 2009/0301970 A1
(43) Pub. Date: Dec. 10, 2009

(54) ETHANOL PLANT RETROFIT WITH VAPOUR SEPARATION MEMBRANES

(76) Inventor: Gaetan Noel, St-Hubert (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/481,178

(22) Filed: Jun. 9, 2009

Related U.S. Application Data
(60) Provisional application No. 61/060,015, filed on Jun. 9, 2008.

(51) Int. Cl. C02F 1/04

(52) U.S. Cl. 210/640; 210/180

(57) ABSTRACT

A system and process removes water from an aqueous fermentation product, for example ethanol, using distillation upstream of a first membrane separation unit to produce hydrous alcohol. Optionally, molecular sieves may be used to further dewater the hydrous alcohol. Another system or process removes water from hydrous ethanol using molecular sieves with a second membrane separation unit to process a regeneration stream. Optionally, there may be a distillation column in the regeneration stream upstream of the membrane separation unit. Further optionally, additional hydrous ethanol may be process through the distillation column or second membrane separation unit, by-passing the molecular sieve unit. These systems and processes may be combined and may be used, individually or together, to retrofit an existing ethanol plant.

This application claims the benefit of provisional application 61/060,015 filed Jun. 9, 2008, entitled Ethanol Plant Retrofit with Vapour Separation Membranes, inventor Gaetan Noel. Application 61/060,015 is incorporated herein in its entirety by this reference to it.

### FIELD

This specification relates to dewatering fermentation products, for example ethanol, to gas or vapour separation, and to retrofitting an ethanol plant.

### BACKGROUND

The following is not an admission that anything discussed below is citable as prior art or part of the common general knowledge.

Plant matter, for example carbohydrates or cellulose, may be processed by various methods including a fermentation step to produce a broth or beer that is primarily water but includes ethanol or other fermentation products, for example butanol or acetone or mixtures of products. Dewatering the broth produces a higher concentration of products such as ethanol, ABE or butanol that may be used as a fuel or a fuel additive. For example, hydrous alcohol having about 93 wt % ethanol may be sold for use in vehicles that run entirely on hydrous alcohol. For further example, anhydrous ethanol having about 99.5 wt % ethanol can be sold for mixing with gasoline or pre-blended with gasoline in mixtures ranging roughly from 5 to 85% anhydrous ethanol.

Distillation can be used to partially dewater the fermentation product, but the energy required in the distillation column reflux loop per volume percent of water removed is significant and increases as the ethanol content increases for a given number of trays in the column. Further, at about 97% ethanol by volume, the ethanol/water azeotrope has been reached and simple distillation is no longer effective and other processes, such as azeotropic distillation or molecular sieves, are required to dry beyond the azeotrope. The energy requirement of these other processes is also a significant problem.

International Patent Application No. PCT/CA2004/001047 filed on Jul. 16, 2004 describes an asymmetric integrally skinned membrane. The membrane can have a vapour permeance to water at least 1×10⁻⁷ mol/m²sPa at a temperature of about 30° C. to about 200° C. The membrane may have a vapour permeance selectivity of at least 50, preferably at least 250 for water/ethanol at a temperature of about 140° C. Application No. PCT/CA2004/001047 is incorporated herein in its entirety by this reference to it.

### INTRODUCTION

The following introduction is not intended to limit or define any claim but instead to introduce the reader to the detailed description that follows.

This specification describes a system and process for removing water from an aqueous fermentation product, for example ethanol, using distillation upstream of a gas separation membrane unit. The output from the membrane separation unit may be hydrous ethanol. The hydrous ethanol may be a product or may be dewatered further, for example with molecular sieves.

This specification also describes a system and process for removing water from a partially dehydrated fermentation product, for example hydrous ethanol, using molecular sieves and a membrane separation unit to process a molecular sieve regeneration stream. Optionally, the regeneration stream may be partially dewatered in a rectification column upstream of the membrane separation unit. Further optionally, a separate stream of partially dehydrated fermentation product may flow to a rectification column upstream of the membrane separation unit. The product from the molecular sieves and the membrane separation unit may be anhydrous ethanol.

This specification also describes a system and process for removing water from an aqueous fermentation product, for example ethanol, using distillation, a first membrane separation unit to further dewater the distillate, a molecular sieve unit to further dewater the product from the first membrane separation unit and a second membrane separation unit to dewater a regeneration stream from the molecular sieve unit.

This specification also describes a method of retrofitting an ethanol plant, and a retrofit plant or process, involving one or more of the systems and processes described above. The retrofit plant or process may have increased production capacity or decreased energy usage per unit of hydrous or anhydrous ethanol produced or both.

### BRIEF DESCRIPTION OF THE FIGURES

FIG. 1 is a schematic flow sheet of the distillation and dehydration section of an ethanol plant using molecular sieves provided as a comparative example.

FIG. 2 is a schematic flow sheet of the distillation and dehydration section of an ethanol plant using vapour separation membranes.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention.

The term hydrous ethanol, when used to refer to a product, means a mixture comprising ethanol in sufficient amount to be used as an engine fuel without being mixed with gasoline. For example, hydrous ethanol may have about 90-95 wt % ethanol. When used generally, or to refer to an intermediate mixture present between process steps, hydrous ethanol means a distillate comprising ethanol that has not be further treated to increase the ethanol content above the azeotrope. For example, hydrous ethanol may have an ethanol content of 70 wt % or more, or 83 wt % or more, to about 90 wt % or 95 wt %. Anhydrous ethanol means a mixture comprising ethanol above the azeotrope. For example, anhydrous ethanol may have about 99 wt % ethanol or more, or an ethanol concentration as required for mixing with gasoline to be used for fuel.

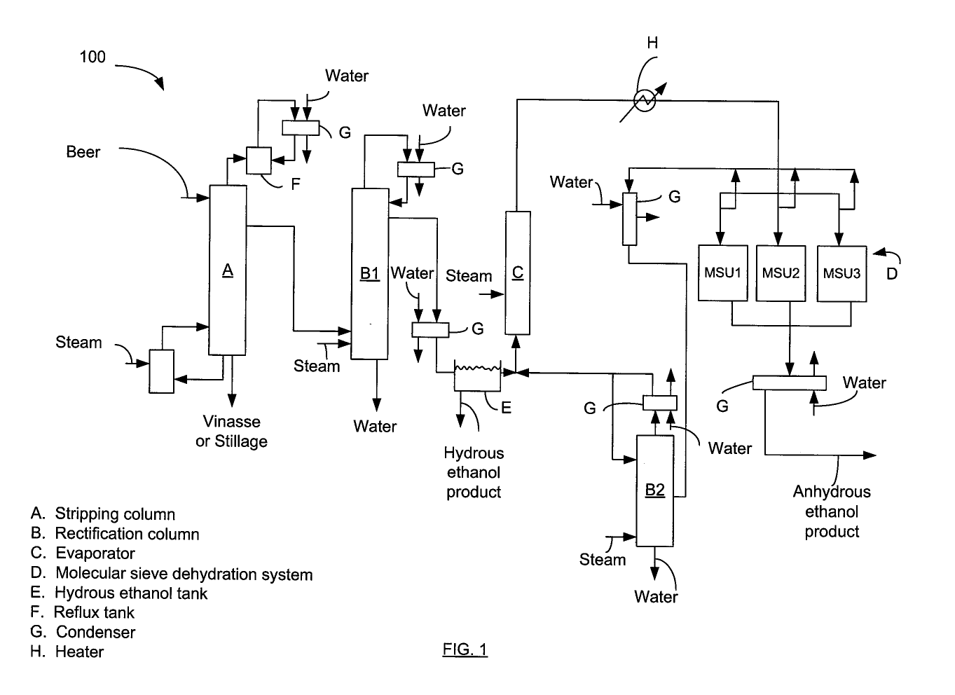

FIG. 1 shows the distillation and dehydration sections of an ethanol plant 100 used to produce both hydrous and anhydrous ethanol. Raw feed is introduced to the plant 100 upstream of the sections shown. The raw feed can be any plant material that may be processed to produce ethanol broth for example corn kernels, sugarcane, switchgrass or other sources of carbohydrates or cellulose. The raw feed passes to a fermenter which is also fed with water, yeast and other fermentation inputs. The fermenter outputs a beer, or broth, which contains ethanol but is mostly water. The beer may contain about 3 to 15 percent, or about 8 to 12 percent, ethanol by volume, although up to 20 percent by volume or more may be possible.

The beer flows, optionally passing through a pre-heater, into the distillation section of the plant 100. The distillation section may have a single-stage, multi-stage or multi-effect column or columns for producing a distilled ethanol with increased ethanol content. In the plant 100 shown, the distillation section has a stripping column A, with a reflux loop and a re-boiler loop, and rectification column B1 with a reflux loop. The rectification column B1 also includes a final stripping section in its lower section to extract water in the feed with minimal losses. In some installations, a separate side stripper is added to the system instead of being incorporated into the rectification column B1 to achieve this objective. The distillation section produces hydrous ethanol to a tank E. Some of the hydrous ethanol is sold as a product and the remainder is dehydrated further. The distilled ethanol may pass through a scrubber before or after the tank E to removes particles and any liquid droplets.

Hydrous ethanol that will be dehydrated further passes through an evaporator to be converted to a vapour mixture. The vapour is heated in a heater H before flowing to a pressure swing molecular sieve semi-continuous dehydration system D comprising three molecular sieve units, MSU1, MS2U, MSU3. At most times, one of the units is active while another is waiting and another is being regenerated. The hydrous ethanol vapour passes through the active unit to produce an anhydrous ethanol vapour. Most of the anhydrous ethanol vapour passes through a condenser G to produce anhydrous ethanol product.

The remainder, roughly 10-33%, of the anhydrous ethanol vapour flows in a reverse direction through the unit being regenerated. This purge or regeneration stream extracts water, as a vapour, from the sub-unit being regenerated. The purge stream flows through a condenser G and is then returned to a rectification column B. In some plants, the purge stream is returned to the main rectification column B1 or to a side stripper adjacent to it. In the plant 100 illustrated, the purge stream flows to a separate, and smaller, rectification column B2 dedicated to dewatering the purge or regeneration stream from the molecular sieve unit. The rectification column B2 produces a top product in a reflux loop, a portion of which is recycled to the evaporator C to be sent back to the molecular sieve units D.

In ethanol plants where an anhydrous ethanol product is not withdrawn, the hydrous ethanol tank E is sometimes still present although it might not have an outlet for hydrous ethanol product. In that case, an intermediate mixture may be liquefied in a hydrous ethanol tank E and then re-vapourized as a means to manage flows and provide a pressure appropriate for use in the molecular sieve dehydration system D. In other ethanol plants where an anhydrous ethanol product is not withdrawn, the hydrous ethanol tank E, the condenser G before it, and evaporator C are not used and instead the output from the rectification column B1 flows directly to the molecular sieve dehydration system D with any required temperature and pressure modifications made in line in the vapour state. In that case, the hydrous ethanol might exist only as it moves through pipes or other devices between the rectification column B1 and the molecular sieve dehydration system D.

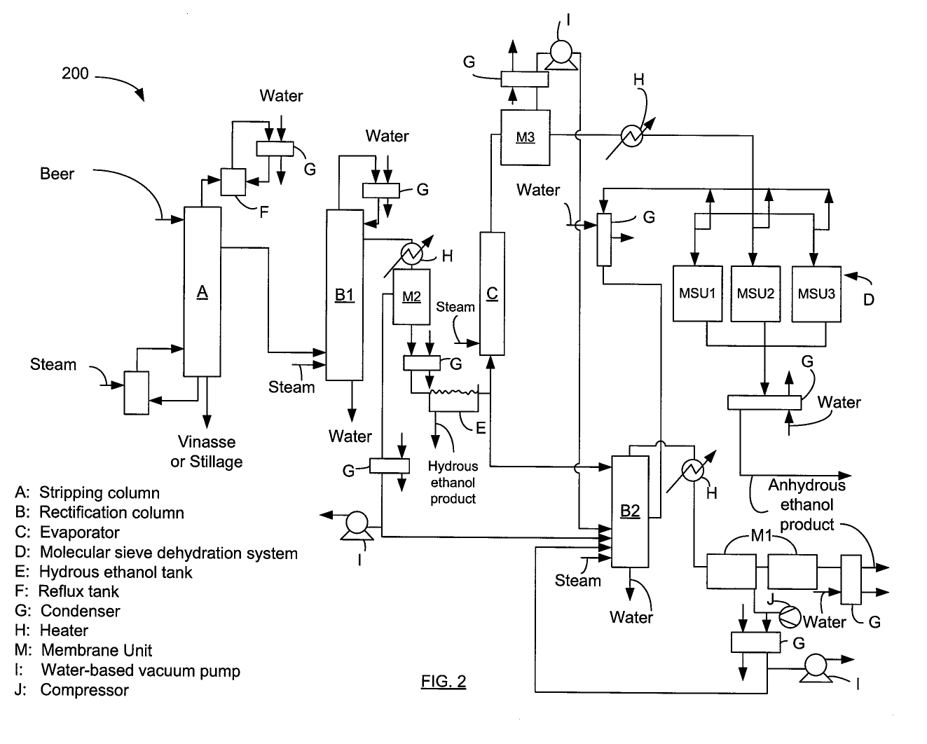

FIG. 2 shows a retrofit plant 200 having changes in the distillation and dehydration sections. While these changes produce cumulative benefits, they may also be implemented individually and provide increased capacity and decreased energy per volume of product when implemented individually. Further, a new plant may be build incorporating one or more features of the retrofit plant 200.

The retrofit plant 200 has membrane units M1, M2 and M3. In general, the membrane units M1, M2 and M3 are fed with a feed vapour mixture and produce retentate vapour with a higher alcohol content and permeate vapour with a higher water content. Membrane units M2 and M3 are single stage units and are driven in part by the pressure of the feed vapour mixture but primarily by a vacuum pump I on the permeate side. Membrane unit M1 is a two-stage unit in which the first stage operates like membrane unit M2. The second stage of membrane unit M1 receives retentate partially dried in the first stage and further dries the retentate. The second stage is driven primarily by a compressor J, for example a Roots blower, with its inlet connected to the permeate side of the second stage. Optionally, the outlet of the compressor J may be mixed with permeate from the first stage. Further optionally, chilled water may be used to condense the second stage permeate to create the vacuum coupled with a small vacuum pump to remove non-condensable parts of the permeate. Suitable membrane modules and single stage and multiple stage membrane separation units are described for example in U.S. patent application Ser. Nos. 11/332,393, 12/038,284 and 12/117,007, which are incorporated herein in their entirety by this reference to them. Other membrane units may be used that provide desired outputs from the inputs. For example, M2 and M3 may be multi-stage units. M1 may be a single stage unit, but is more likely to have two or more stages if producing anhydrous ethanol vapour retentate as in plant 200.

The membrane units M1, M2 and M3 may use polymeric membranes, for example polyimide hollow fibers. A hollow fibre module may be fed to the insides of the hollow fibres. The membranes may be asymmetric integrally skinned polyimide membranes as described, for example, in International Patent Application No. PCT/CA2004/001047. Such membranes can have a vapour permeance for water of 4×10⁻⁷ mol/m²sPa or more at about 80° C. The membranes can have a vapour permeance selectivity of 250 or more for water/ethanol at about 140° C.

In a first change, membrane unit M2, is added downstream of the distillation unit. In the retrofit plant 200 as shown, retentate from the membrane unit M2 flows into the hydrous ethanol tank E. Optionally, some or all of the retentate may flow directly to the molecular sieve unit D without being liquefied or passing through a liquid holding tank. Permeate from membrane unit M2 may be sent to rectification column B2 or, optionally, to rectification column B1 or stripping column A. Membrane unit M2 may be used to increase the ethanol content of an intermediate hydrous ethanol (while the output from rectification column B1 unchanged) to reduce the energy consumption or purge stream flow rate of the molecular sieve unit D. However, in the plant 200 as shown, hydrous ethanol is produced in tank E with the same ethanol content, about 93 wt %, as in plant 100 for use either as product or an intermediate. However, because the membrane unit M2 increases the ethanol content of vapour mixture passing through it, rectification column B1 can be operated so as to produce a lower ethanol content than in plant 100 which in turn allows either higher throughput or lower energy consumption per unit of hydrous ethanol produced or both. Optionally, the distillation section can be modified so as to be to optimized for the production of a lower ethanol content distillate, for example having an ethanol content of 70 wt % to 90 wt %. However, it may be useful to remove fusel oils in the distillation section, for example where hydrous ethanol will be removed as a product and used as fuel. In such a case the distillation section should not be modified or operated so as to produce less than 83 wt % or 85 wt % ethanol so that fusel oils will be substantially removed in the distillation section.

In a second change, the reflux loop and recycle line to the evaporator are removed from the top of rectification column B2. Instead, the top product from rectification column B2 is sent to membrane unit M1. Membrane unit M1, as described above, produces anhydrous ethanol product. Because most of the ethanol in the purge stream is converted directly to product and removed from the plant 200, a correspondingly greater amount of hydrous ethanol can be drawn from tank E and sent to the molecular sieve units D. The production of anhydrous ethanol therefore increases. Energy required per unit of anhydrous ethanol produced also decreases. Optionally, the rectification column B2 may be removed and the regeneration stream from the molecular sieve unit D sent directly (with any appropriate temperature or pressure adjustments) to membrane unit M1.

Permeate from the membrane unit M1 may be returned to the rectification column B2, or if there is none, to rectification column B1 or to stripping column A. Optionally, the second stage of membrane unit M1 may be omitted or connected such that it can be by-passed. In this way, membrane until M1 may be operated as a single stage unit to produce hydrous ethanol either as a product or for recycle to the hydrous ethanol tank E.

In a third change, a pipe is provided between the hydrous alcohol tank E and the rectification column B2, or directly to membrane unit M1. This change, though possible to implement in a new plant, is particularly suited to a retrofit plant in which the reflux loop has been removed from the rectification column B2 of an existing plant. In that case, rectification column B2, having been designed to accept the molecular sieve unit D purge stream with a reflux loop, will have available excess capacity when treating the purge stream in a single pass. The excess capacity is used to treat hydrous ethanol from tank E. Membrane unit M1 is made larger to accommodate the increased flow through it. This change increases the production of anhydrous ethanol and also reduces the energy required per unit of anhydrous ethanol produced.

In a fourth change, membrane unit M3 is added downstream of the molecular sieve feed evaporator C. In the retrofit plant 200 as shown, retentate from the membrane unit M3 flows directly to the molecular sieve unit D. Permeate from membrane unit M3 may be sent to rectification column B2 or, optionally, to rectification column B1 or stripping column A. Membrane unit M3 may be used to increase the ethanol content of the molecular sieve feed to reduce the energy consumption or purge stream flow rate of the molecular sieve unit D. Membrane unit M3 may also be used to increase the capacity of the molecular sieve unit D or to maintain the molecular sieve unit D capacity if higher ethanol content (lower water content) is desired to accommodate any new market requirement.

In plant 200, some hydrous ethanol is withdrawn as a product from hydrous ethanol tank E. In that case, the ethanol content in the hydrous ethanol tank E is related to market requirements. Further in that case, adding membrane unit M2 primarily reduces load on the distillation section of plant 200 whereas membrane unit M3 primarily reduces load on the molecular sieve unit D. If hydrous ethanol is not removed as a product, then one of membrane units M2 and M3, or a multi-stage membrane unit, can be used to provided selected load reduction to either the distillation section or molecular sieve unit D or both depending on the selection of feed and retentate ethanol concentrations.

While various examples of devices or processes have been described above, various other specific devices or processes may also be within the scope of the invention defined by the following claims. In particular, but without limitation, while the retrofit of a particular ethanol plant has been described, the invention may be applied to processing or dewatering other fermentation products in new or retrofit plants of different configurations.

I claim:

1. A process for removing water from a mixture comprising a fermentation product and water, the process comprising steps of,
a) distilling the mixture to produce a distillate with a lower concentration of water than the mixture; and,
b) permeating water from the distillate through a gas separation membrane to produce a retentate, the retentate having a lower concentration of water than the distillate.

2. The process of claim 1 further comprising a step of passing the retentate through a molecular sieve to produce an anhydrous ethanol product.

3. The process of claim 2 wherein the retentate is a hydrous ethanol product.

4. The process of claim 2 further comprising a step of further processing the permeate in a rectification column or membrane separation unit or both to produce an anhydrous ethanol product.

5. A process for removing water from a partially dehydrated mixture comprising a fermentation product and water comprising steps of,
a) passing the mixture through a molecular sieve to produce a substantially dehydrated product;
b) passing a portion of the substantially dehydrated product through the molecular sieve in reverse direction to regenerate the molecular sieve and produce a regeneration stream; and,
c) permeating water from the regeneration stream through a membrane separation unit to produce additional substantially dehydrated product.

6. The process of claim 5 further comprising partially dewatering the regeneration stream in a rectification column upstream of the membrane separation unit.

7. The process of claim 5 further comprising permeating water from the partially dehydrated mixture through a membrane separation unit to produce additional substantially dehydrated product.

8. The process of claim 5 wherein the substantially dehydrated product is anhydrous ethanol.

9. The process of claim 5 wherein the partially dehydrated mixture is retentate produce by the process of claim 1.

10. An apparatus for removing water from a mixture comprising a fermentation product and water comprising,
a) a distillation section;
b) a molecular sieve unit connected to receive distillate from the distillation section, the distillate having a lower concentration of water than the mixture; and,
c) a membrane separation unit,
wherein the membrane separation unit is located to intercept distillate flowing between the distillation section and the molecular sieve unit or to process a regeneration stream from the molecular sieve unit.

11. The apparatus of claim 10 wherein the membrane separation unit is located to intercept distillate flowing between the distillation section and the molecular sieve unit, wherein further de-watered retentate flows from the membrane separation unit to the molecular sieve unit.

12. The apparatus of claim 11 having a distillation column or membrane separation unit or both connected to receive permeate from the membrane separation unit.

13. The apparatus of claim 10 wherein the membrane separation unit is located to process a regeneration stream from the molecular sieve unit.

14. The apparatus of claim 13 further comprising a distillation column located to intercept the regeneration stream between the molecular sieve unit and the membrane separation unit.

15. The apparatus of claim 14 wherein the distillation column is connected to receive the regeneration stream from the molecular sieve unit, the membrane separation unit is connected to receive an overhead stream from the distillation column, and a permeate from the membrane separation unit it recycled to the distillation column.
